(19) United States
(12) Patent Application Publication
(10) Pub. No.: US 2006/0245491 A1
(43) Pub. Date: Nov. 2, 2006

(54) Method and circuit for transcoding transform data

(76) Inventors: Mehrban Jam, Fremont, CA (US); Bo Shen, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/117,105

(22) Filed: Apr. 28, 2005

(51) Int. Cl. H04N 11/04; H04N 11/02; H04B 1/66; H04N 7/12

(52) U.S. Cl. 375/240.2; 375/240.24

(57) ABSTRACT

A method and circuit for transcoding first transform data to second transform data. A low-pass band block is extracted from an input first transform data block. The low-pass band block is transcoded by performing a matrix operation on the low-pass band block using a transcoding matrix to generate a transcoded second transform data block.

### TECHNICAL FIELD

Embodiments of the present invention relate to the field of data transcoding. Specifically, embodiments of the present invention relate to a method and circuit for transcoding first transform data to second transform data.

### BACKGROUND

Currently, the majority of existing video coding standards use 8×8 discrete cosine transform (DCT) coding blocks. For example, these video coding standards include Moving Pictures Experts Group (MPEG) 1, MPEG-2, MPEG-4, or H.263. Recently, new video coding standards, such as H.264 and MPEG-4-AVC, have been proposed that use 4×4 integer transform coding blocks. In order to provide the widest use and acceptance of these new video standards, it will be desirable to convert existing video to the new standard.

H.264 and other similar standards based on 4×4 integer transform coding blocks provide a higher compression ratio than video standards based on 8×8 DCT coding blocks. Currently, the only way to convert the old DCT based video to the new integer transform based video is to fully decode the DCT blocks and fully re-encode them into integer transform blocks. Specifically, the conversion is achieved by performing an 8-tap inverse transformation followed by a 4-tap forward transformation. Given so much content already exist in MPEG-like format, e.g., many high quality digital films and surveillance videos are maintained in the MPEG form, a re-encode approach greatly wastes computing power and renders the conversion non-real time.

Accordingly, a need exists for a method for efficiently converting video based on DCT coding blocks to video based on integer transform coding blocks.

### DISCLOSURE OF THE INVENTION

A method and circuit for transcoding first transform data to second transform data. A low-pass band block is extracted from an input first transform data block. The low-pass band block is transcoded by performing a matrix operation on the low-pass band block using a transcoding matrix to generate a transcoded second transform data block.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a block diagram of system for transcoding discrete cosine transform (DCT) data to integer transform data, in accordance with an embodiment of the present invention.

FIG. 2 illustrates a block diagram of a transcoding portion, in accordance with an embodiment of the present invention.

FIG. 3A illustrates a circuit diagram of a circuit for approximating a multiplication operation B*0.9975 using a subtraction operation and a shift operation, in accordance with an embodiment of the present invention.

FIG. 3B illustrates a circuit diagram of a circuit for approximating a multiplication operation B*0.0707 using a shift operation, in accordance with an embodiment of the present invention.

FIG. 4 illustrates a circuit diagram of circuit for transcoding DCT data to integer transform data, in accordance with an embodiment of the present invention.

FIG. 5 illustrates a flow chart of a process for transcoding DCT data to integer transform data, in accordance with an embodiment of the present invention.

FIG. 6 illustrates a flow chart of a matrix operation, in accordance with an embodiment of the present invention.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

Aspects of the present invention may be implemented in a computer system that includes, in general, a processor for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

Various embodiments of the present invention provide a method, system and circuit for transcoding first transform data to second transform data. For purposes of simplicity and understanding, the described embodiments are directed towards a method, system and circuit for transcoding discrete cosine transform (DCT) data to integer transform data. However, it should be appreciated that the described embodiments may be applicable for transcoding other types of transform data. The described embodiments may be used where there is a derivation relationship between the two types of transform data, e.g., where the second transform data is derived from the first transform data. For instance, DCT data and integer transform data are both orthogonal, thus providing compressional efficiency.

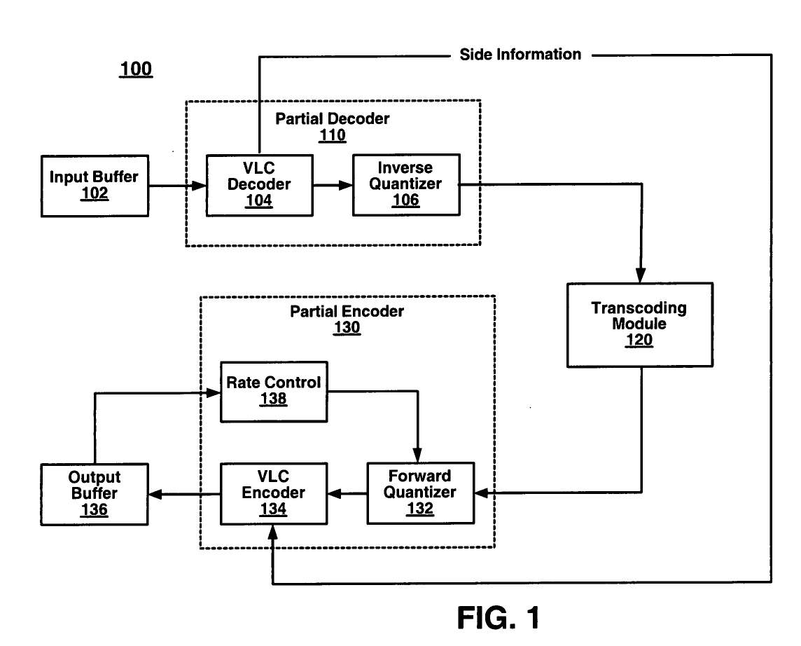

FIG. 1 illustrates a block diagram of system 100 for transcoding DCT data to integer transform data, in accordance with an embodiment of the present invention. System 100 is for efficiently transcoding data from a video format using DCT data to a video format using integer transform data. System 100 includes input buffer 102, partial decoder 110, transcoding module 120, partial encoder 130, and output buffer 136. It should be appreciated that system 100 and its components may be implemented as hardware components or software components, and any combination thereof. In one embodiment, input buffer 102, partial decoder 110, partial encoder 130, and output buffer 136 are implemented as software and transcoding module 120 is implemented as an integrated circuit (IC).

Input buffer 102 receives input video in a format that is based on compression using DCT data. Examples of such input video include, but are not limited to, Moving Pictures Experts Group (MPEG) 1, MPEG-2, MPEG-4, or H.263. The input video is forwarded to partial decoder 110 for partially decoding the input video to obtain DCT data blocks.

In one embodiment, partial decoder 110 includes Variable Length Coding (VLC) decoder 104 and inverse quantizer 106. It should be appreciated that partial decoder 110 may include additional or different components, and is not limited to the described embodiment. In one embodiment, side information generated at VLC decoder 104 is forwarded on to partial decoder 130. For example, the side information may include macroblock coding information that is reused by VLC encoder 134. For example, one type of macroblock coding information is the motion vector coding type.

Partial decoder 110 is operable to partially decode the video input to obtain DCT data blocks. In one embodiment, the DCT data blocks are 8×8 DCT data blocks, also referred to as 8-tap DCT data blocks. The DCT blocks are forwarded on to transcoding module 120. It should be appreciated that by only partially decoding the video input into DCT blocks, a substantial amount of computational overhead is saved because the DCT blocks do not require decoding, which is computationally intensive.

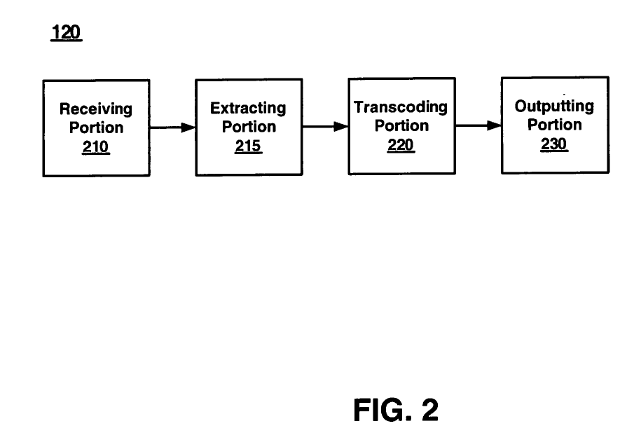

Transcoding module 120 is for transcoding a DCT block into an integer transform block. FIG. 2 illustrates a block diagram of transcoding module 120, in accordance with an embodiment of the present invention. Transcoding module 120 includes receiving portion 210, extracting portion 215, transcoding portion 220, and outputting portion 230. It should be appreciated that transcoding module 120 and its components may be implemented as hardware components or software components, and any combination thereof. In one embodiment, receiving portion 210, extracting portion 215, and outputting portion 230 are implemented as software and transcoding portion 220 is implemented as an integrated circuit (IC).

Receiving portion 210 is operable to receive DCT blocks as input. In one embodiment, the DCT blocks are 8-tap DCT blocks. Extracting portion 215 is operable to extract data from the DCT blocks. In one embodiment, where the DCT blocks are 8-tap DCT blocks, extracting portion 215 is for extracting a 4×4 data block, also referred to as a 4-tap data block. It should be appreciated that DCT encoding and decoding typically uses 8-tap DCT blocks and integer transform encoding and decoding typically uses 4-tap integer transform blocks. Accordingly, a 4-tap data block is extracted from the 8-tap DCT block to extract a 4-tap data block.

In one embodiment, extracting portion 215 is operable to extract a low-pass band block from the DCT block. In one embodiment the low-pass band block is a 4×4 data block. For example, the low-pass band block of an 8×8 DCT block is the upper left quadrant (4×4) of the DCT block. Extracting the low-pass band block represents a reduction in resolution by a factor of two. The extracted low-pass band block is passed forwarded to transcoding portion 220.

Transcoding portion 220 is operable to transcode the low-pass band block by performing a matrix operation on the low-pass band block. For purposes of simplifying the following discussion, the low-pass band block is represented as matrix B, where:

$$B = [ \begin{matrix}B 00 & B 01 & B 02 & B 03 \\ B 10 & B 11 & B 12 & B 13 \\ B 20 & B 21 & B 22 & B 23 \\ B 30 & B 31 & B 32 & B 33\end{matrix} ]$$

A unique integer transform transcoding matrix is used in the matrix operation to generate a transcoded integer transform block. The integer transform transcoding matrix, represented as A, is the matrix that is operable to transform low-pass band block B, which is in DCT format, into the transcoded integer transform block, which is in integer transform format. In one embodiment, the integer transform transcoding matrix A is represented as:

$$A = [ \begin{matrix}1 & 0 & 0 & 0 \\ 0 & a & 0 & b \\ 0 & 0 & 1 & 0 \\ 0 & - b & 0 & a\end{matrix} ]$$

where a is substantially equal to 0.9975 and b is substantially equal to 0.0707.

Transcoding portion 220 is operable to perform the matrix operation using integer transform transcoding matrix A to transcode input matrix low-pass band block B, generating an transcoded integer transform block, represented as B′. In one embodiment, the matrix operation is performed according to Equation 1:

$${B}^{′} = \frac{{A}^{T} * B * A}{2}$$

Accordingly, transcoded integer transform block B′ is represented as:

| B′ = | |
|---|---|
| [ | |
| B00, B01*a−B03*b, B02, | B01*b+B03*a; |
| a*B10−b*B30, (a*B11−b*B31)*a− a*B12−b*B32 | (a*B11−b*B31)*b |
| (a*B13−b*B33)*b, | +(a*B13−b*B33)*a; |
| B20, B21*a−B23*b, B22 | B21*b+B23*a; |
| b*B10+a*B30, (b*B11+a*B31)*a− b*B12+a*B32, | (b*B11+a*B31)*b+ |
| (b*B13+a*B33)*b, | (b*B13+a*B33)*a |
| ]/2. | |

The transcoded integer transform block is forwarded to outputting portion 230 for outputting said transcoded integer transform block.

With reference to FIG. 1, the transcoded integer transform block is received at partial encoder 130. In one embodiment, partial encoder is an integer transform encoder for encoding the transcoded integer transform block (e.g., a 4-tap integer transform block) into video output. In one embodiment, the integer transform encoder is an H. 264 video format encoder for encoding video in accordance with the H.264 video format. It should be appreciated that partial encoder 130 may include any encoder or partial encoder for encoding video based on an integer transform block, such as the MPEG-4-AVC format.

In one embodiment, partial encoder 130 includes forward quantizer 132, VLC encoder 134, and rate control 138. It should be appreciated that partial encoder 130 may include additional or different components, and is not limited to the described embodiment. In one embodiment, the side information generated at VLC decoder 104 is reused at VLC encoder 134. In one embodiment, the side information includes macroblock coding information reused at VLC encoder 134. Forward quantizer 132 is operable to quantize the integer transform block according to rate control 138. Output buffer 136 collects and transmits the output video.

It should be appreciated that system 100 is operable to transcode inter frames or inter macroblocks of the input video. In one embodiment, the transcoding of the intra frames or intra macroblocks in inter frames is performed by re-encoding. In one embodiment, the re-encoding includes fully decoding the input video followed by a full encoding to generate the output video.

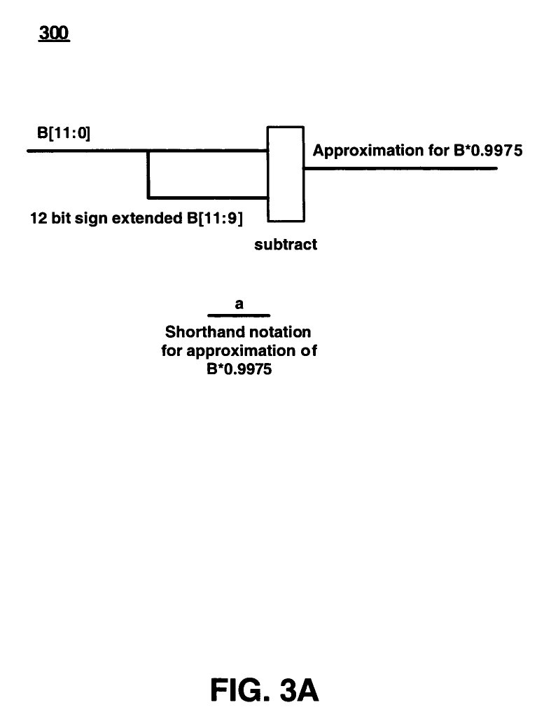

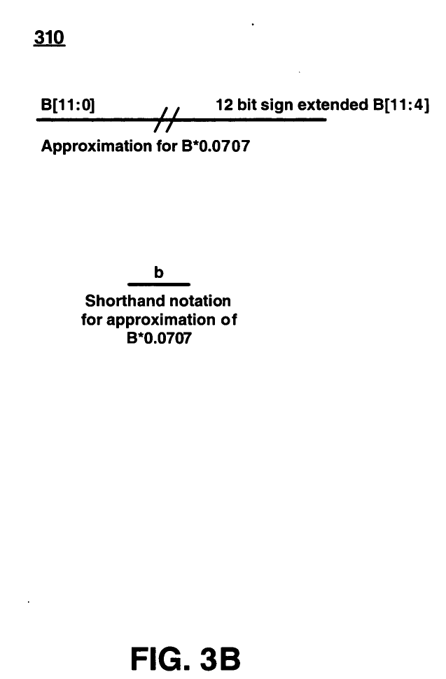

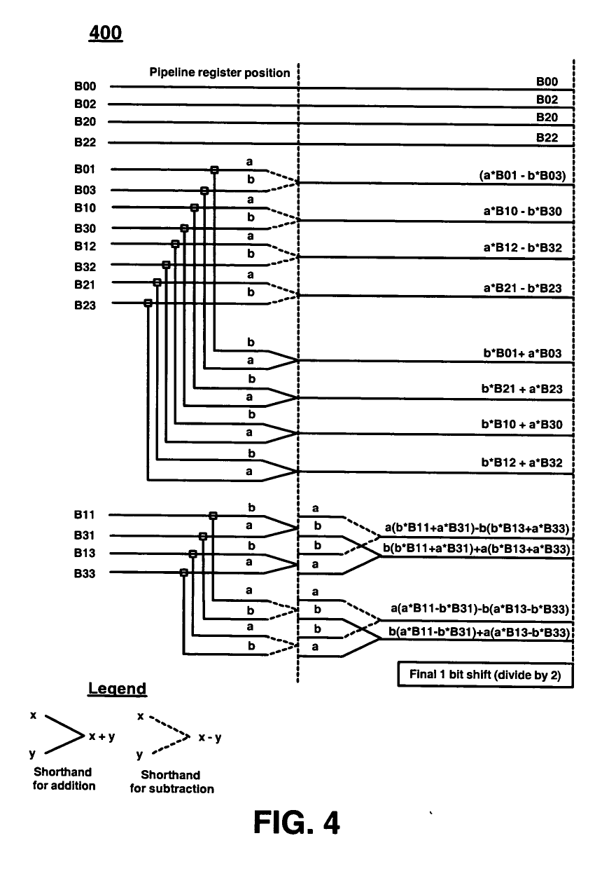

As described above, in one embodiment, the transcoding of DCT data into integer transform data is performed at an integrated circuit. The integrated circuit is operable to perform the matrix operation described in Equation 1. The matrix operations performed are multiplication, addition and subtraction, where the multiplication factors are a≈0.9975 and b≈0.0707. The discussion of the circuit for transcoding DCT data to integer transform data as described in conjunction with FIGS. 3A, 3B and 4 is based on the MPEG-2 format. However, it should be appreciated that the described circuit may support any video compression format based on DCT data.

The range of coefficients in matrix B is from −2048 to +2047 (a range supported by MPEG-2) and are represented by a 12 bit integer. In one embodiment, the circuit may be implemented using a floating point multiplier. However, multiplication operations in general, and floating point multipliers in particular, are costly when implemented in an integrated circuit. In order to efficiently transcode the DCT data into integer transform data, the described circuit has eliminated most multiplication operations, which are costly when implemented in an integrated circuit. The multiplication operations have been replaced with less costly shift, addition, and subtraction operations.

In the following description of FIGS. 3A, 3B and 4, B is used to represent coefficients in matrix B. FIG. 3A illustrates a circuit diagram of a circuit 300 for approximating a multiplication operation B*0.9975 using a subtraction operation and a shift operation, in accordance with an embodiment of the present invention. 0.9975 can be written as (1−0.0025) or 1− 1/400. Therefore, operation B*0.9975 is equal to B−B/400. The division operation can be approximated by a binary shift operation. In one embodiment, 400 is approximated as 512. With this approximation B*0.9975 is approximately equal to B−(B>>9), where >> represents a binary shift operation. As shown in FIG. 3A, B[11:9] is subtracted from B[11:0] as X−Y, thus providing an approximation for B*0.9975. For purposes of simplicity, circuit 300 is represented as in circuit 400 of FIG. 4.

FIG. 3B illustrates a circuit diagram of a circuit 310 for approximating a multiplication operation B*0.0707 using a shift operation, in accordance with an embodiment of the present invention. 0.0707 can be written as 1/14.14. Operation B*0.0707 is substantially equal to B/14.14. The division operation can be approximated by a binary shift operation. In one embodiment, 14.14 is approximated as 16. With this approximation B*0.0707 is approximately (B>>4). As shown in FIG. 3B, B[11:0] is shifted four places to generate B[11:4], thus providing an approximation for B*0.9975 The shift operations as described in FIGS. 3A and 3B are essentially free in terms of circuit resources and subtraction operations are considerably less expensive in terms of circuit resources and timing than multiplication operations. For purposes of simplicity, circuit 310 is represented as b in circuit 400 of FIG. 4.

FIG. 4 illustrates a circuit diagram of circuit 400 for transcoding DCT data to integer transform data, in accordance with an embodiment of the present invention. Circuit 400 approximates the matrix operation described above at Equation 1. As shown in the legend, shorthand for an addition operation is indicated as solid lines and shorthand for a subtraction operation is indicated as dashed lines. Furthermore, circuit 300 of FIG. 3A is represented as a with a solid line underneath and circuit 310 of FIG. 3B is represented as b with a solid line underneath. The representations of circuits 300 and 310 are provided to simplify the presentation of circuit 400, as circuit 400 includes sixteen of circuits 300 and circuits 310.

Various embodiments of circuit 400 may include a number of optimizations. For example, the longest operations chains (B11, B31, B13, and B33 paths) include four add/subtract operations. In one embodiment, a set of pipeline registers can be inserted in the middle as indicated by the vertical dashed line to substantially double the processing speed. In present embodiment, the longest operations will consist of two add/subtract operations.

It should be appreciated that the implementation of circuit 400 is not resource efficient. Specifically, circuit 400 is a pad limited design. Circuit 400 mainly includes forty-eight 12-bit add/subtract blocks, which is relatively insignificant in number of gates in modern IC technology. However, circuit 400 includes a high number of input/output (I/O) pins. As shown, circuit 400 includes 384 pins (12-bits*32 total circuits 300 and 310). 384 pins is fairly expensive in terms of IC packaging.

The essential tradeoff in implementing circuit 400 is to trade the number of I/O pins in the package with the I/O speed of the chip by serializing the I/O streams. In one embodiment, where there is no I/O serialization, circuit 400 requires 384 pins and samples are applied and retrieved from circuit 400 at the rate of 1 dataset per clock cycle. In another embodiment, the input and output streams are serialized on one serial pin each. In the present embodiment, each dataset takes 16*12=192 clock cycles to process, but circuit 400 will consist of only two I/O pins, and a minimum of two clock and framing pins. It should be appreciated that these described embodiments represent the extreme cases of the implementation of circuit 400. Specifically, the first embodiment provides a high computational rate, but is a very large and potentially costly circuit. At the other extreme, the second embodiment provides a low cost and small circuit, but operates at a much slower speed.

Modern IC design considers problem of expensiveness of I/O pins and provide solutions for it. In order to provide an optimal implementation of circuit 400, an IC designer would weigh the tradeoffs described above. To increase the processing speed an implementation can be chosen between the two extreme cases described above. In one embodiment, each input and output shown in FIG. 4 can be serialized. In the present embodiment, there will be 16 input and 16 output pins for a total of 32 I/O pins, each serializing 12 bits. In one embodiment, 32 I/O pins provides a processing rate of approximately 1 G/12=83 Mega dataset/second.

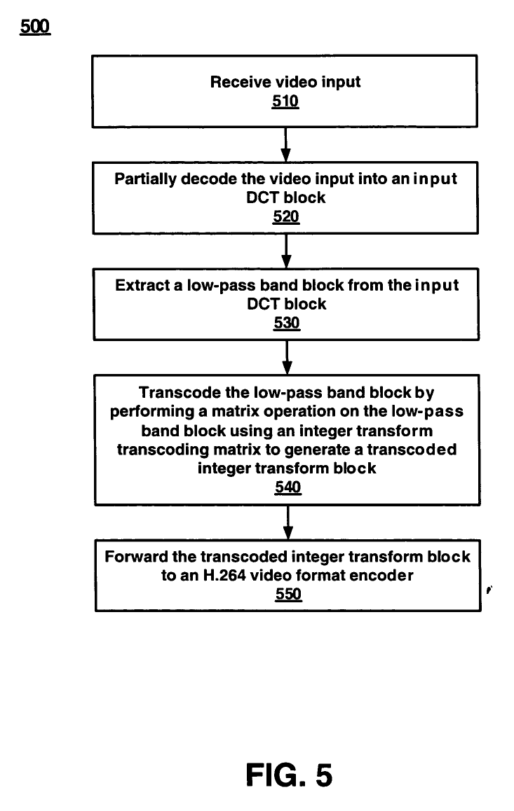

FIG. 5 illustrates a flow chart of a process 500 for transcoding DCT data to integer transform data, in accordance with an embodiment of the present invention. In one embodiment, process 500 is carried out by processors and electrical components (e.g., a computer system or an integrated circuit) under the control of computer readable and computer executable instructions, such as system 100 of FIG. 1. Although specific steps are described in process 500, such steps are exemplary. That is, the embodiments of the present invention are well suited to performing various other steps or variations of the steps recited in FIG. 5.

At step 510 of process 500, video input is received. The input video is received in a format that is based on compression using DCT data. Examples of such input video include, but are not limited to, Moving Pictures Experts Group (MPEG) 1, MPEG-2, MPEG-4, or H.263. In one embodiment, the video input is received at input buffer 102 of FIG. 1.

At step 520, the video input is partially decoded into input DCT blocks. In one embodiment, the input DCT blocks are 8×8 data blocks. In one embodiment, the video input is partially decoded at partial decoder 110 of FIG. 1.

At step 530, a low-pass band block is extracted from an input DCT block. In one embodiment, the low-pass band block is a 4×4 data block. In one embodiment, the low-pass band block is extracted at extracting portion 215 of FIG. 2.

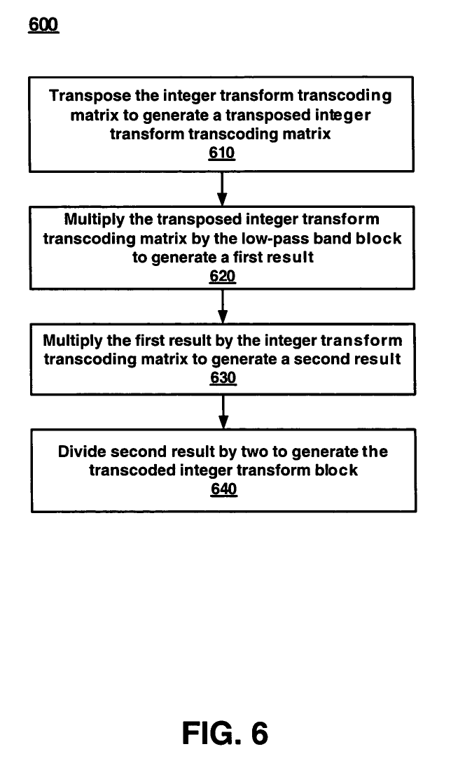

At step 540, the low-pass band block is transcoded by performing a matrix operation on the low-pass band block using an integer transform transcoding matrix to generate a transcoded integer transform block. In one embodiment, the transcoded integer transform block is a 4×4 data block. In one embodiment, the low-pass band block is transcoded at transcoded portion 220 of FIG. 2. In one embodiment, the matrix operation is described in Equation 1 above and in FIG. 6.

FIG. 6 illustrates a flow chart of a matrix operation 600, in accordance with an embodiment of the present invention. In one embodiment, matrix operation 600 is carried out by processors and electrical components (e.g., a computer system or an integrated circuit) under the control of computer readable and computer executable instructions, such as transcoding module of FIG. 2 or circuit 400 of FIG. 4. Although specific steps are described in matrix operation 600, such steps are exemplary. That is, the embodiments of the present invention are well suited to performing various other steps or variations of the steps recited in FIG. 6.

At step 610, the integer transform transcoding matrix is transposed to generate a transposed integer transform transcoding matrix. In one embodiment, the integer transform transcoding matrix is substantially equal to matrix A as described above. At step 620, the transposed integer transform transcoding matrix is multiplied by the low-pass band block to generate a first result. At step 630, the first result is multiplied by the integer transform transcoding matrix to generate a second result. At step 640, the second result is divided by two to generate the transcoded integer transform block.

With reference to FIG. 5, at step 550, the transcoded integer transform block is forwarded to an H.264 video format encoder. H.264 is a video compression standard based on integer transform data. It should be appreciated that the transcoded integer transform block may be forwarded to any type of video encoder operable to encode video based on integer transform data, and is not limited to an H.264 video format encoder. In one embodiment, the H.264 video format encoder is partial encoder 130 of FIG. 1.

Various embodiments of the present invention provide a method, system and circuit for transcoding DCT data to integer transform data. The present invention provides an efficient solution for transcoding the data by directly transcoding the DCT blocks into integer transform blocks, and not requiring a complete decoding of the DCT blocks. In one embodiment, the present invention provides for transcoding 8-tap DCT blocks to 4-tap integer-transform blocks. In one embodiment, the present invention uses 16-bit multiplication for exact transcoding. In another embodiment, the present invention uses add, subtraction or shift operations for high precision transcoding using an integrated circuit.

Embodiments of the present invention, a method and circuit for transcoding transform data, are thus described. While the present invention has been described in particular embodiments, it should be appreciated that the present invention should not be construed as limited by such embodiments, but rather construed according to the following claims.

What is claimed is:

1. A method for transcoding first transform data to second transform data, said method comprising:
extracting a low-pass band block from an input first transform data block; and
transcoding said low-pass band block by performing a matrix operation on said low-pass band block using a transcoding matrix to generate a transcoded second transform data block.

2. The method as recited in claim 1 wherein said first transform data comprises discrete cosine transform (DCT) data and said second transform data comprises integer transform data.

3. The method as recited in claim 2 wherein said input DCT data block is an 8×8 data block, said low-pass band block is a 4×4 data block, and said transcoded integer transform data block is a 4×4 data block.

4. The method as recited in claim 2 wherein said matrix operation comprises:
transposing said transcoding matrix to generate a transposed transcoding matrix;
multiplying said transposed transcoding matrix by said low-pass band block to generate a first result;
multiplying said first result by said transcoding matrix to generate a second result; and
dividing said second result by two to generate said transcoded integer transform data block.

5. The method as recited in claim 2 wherein said transcoding matrix is substantially equal to:
$$[ \begin{matrix}1 & 0 & 0 & 0 \\ 0 & 0.9975 & 0 & 0.0707 \\ 0 & 0 & 1 & 0 \\ 0 & - 0.0707 & 0 & 0.9975\end{matrix} ] .$$

6. The method as recited in claim 1 further comprising:
receiving video input; and
partially decoding said video input into said input first transform data block.

7. The method as recited in claim 2 further comprising forwarding said transcoded integer transform data block to an H.264 video format encoder.

8. The method as recited in claim 1 wherein said transcoding said low-pass band block is performed at an integrated circuit.

9. A system for transcoding first transform data to second transform data, said system comprising:
a partial decoder for decoding video input into a plurality of first transform data blocks;
a transcoding module for transcoding said plurality of first transform data blocks into a corresponding plurality of second transform data blocks; and
an encoder for encoding said plurality of second transform data blocks into video output.

10. The system as recited in claim 9 wherein said first transform data comprises discrete cosine transform (DCT) data and said second transform data comprises integer transform data.

11. The system as recited in claim 10 wherein said plurality of DCT data blocks are an 8×8 data blocks and said plurality of transcoded integer transform data blocks are 4×4 data blocks.

12. The system as recited in claim 10 wherein said transcoding module is for extracting a plurality of low-pass band blocks from said plurality of DCT data blocks and for transcoding said plurality of low-pass band blocks by performing a matrix operation on said plurality of low-pass band blocks using an integer transform transcoding matrix to generate said plurality of transcoded integer transform data blocks.

13. The system as recited in claim 12 wherein said matrix operation comprises:
transposing said integer transform transcoding matrix to generate a transposed integer transform transcoding matrix;
multiplying said transposed integer transform transcoding matrix by a low-pass band block of said plurality of low-pass band blocks to generate a first result;
multiplying said first result by said integer transform transcoding matrix to generate a second result; and
dividing said second result by two to generate a transcoded integer transform data block of said plurality of transcoded integer transform data blocks.

14. The system as recited in claim 12 wherein said integer transform transcoding matrix is substantially equal to:
$$[ \begin{matrix}1 & 0 & 0 & 0 \\ 0 & 0.9975 & 0 & 0.0707 \\ 0 & 0 & 1 & 0 \\ 0 & - 0.0707 & 0 & 0.9975\end{matrix} ] .$$

15. The system as recited in claim 9 wherein said encoder is an H.264 video format encoder.

16. The system as recited in claim 9 wherein said transcoding module is comprised within an integrated circuit.

17. A circuit for transcoding first transform data to second transform data, said circuit comprising:
a receiving portion for receiving a low-pass band block extracted from an input first transform data block;
a transcoding potion for transcoding said low-pass band block by performing a matrix operation on said low-pass band block using a transcoding matrix to generate a transcoded second transform data block; and
an outputting portion for outputting said transcoded second transform data block.

18. The circuit as recited in claim 17 wherein said first transform data comprises discrete cosine transform (DCT) data and said second transform data comprises integer transform data.

19. The circuit as recited in claim 18 wherein said input DCT data block is an 8×8 data block, said low-pass band block is a 4×4 data block, and said transcoded integer transform data block is a 4×4 data block.

20. The circuit as recited in claim 17 wherein said transcoding matrix is defined as:
$$[ \begin{matrix}1 & 0 & 0 & 0 \\ 0 & a & 0 & b \\ 0 & 0 & 1 & 0 \\ 0 & - b & 0 & a\end{matrix} ] ;$$
wherein a is represented as a coefficient of said low-pass band block minus said coefficient shifted nine places to the right in accordance with a binary subtraction operation and a binary shift operation, and wherein b is represented as said coefficient shifted four places to the right in accordance with a binary shift operation.

21. The circuit as recited in claim 17 further comprising an extraction portion for extracting said low-pass band block from said input first transform data block.

22. The circuit as recited in claim 17 wherein said outputting portion is operable to forward said transcoded second transform data block to an H.264 video format encoder.
